(19) United States
(12) Patent Application Publication
(10) Pub. No.: US 2016/0216941 A1
(43) Pub. Date: Jul. 28, 2016

(54) SYSTEM FOR AVATAR TO VOICE READ MESSAGES

(71) Applicants: Duane Ramseur, Clairton, PA (US); Betty Ramseur, Clairton, PA (US)

(72) Inventors: Duane Ramseur, Clairton, PA (US); Betty Ramseur, Clairton, PA (US)

(21) Appl. No.: 14/603,692

(22) Filed: Jan. 23, 2015

(51) Int. Cl. G06F 3/16; G10L 15/22; G10L 17/22; G06F 3/0484

(52) U.S. Cl. CPC G06F 3/167; G06F 3/04847; G06F 3/04842; G10L 15/22; G10L 17/22; G10L 2015/223

(57) ABSTRACT

A system for an avatar to read an message comprising a program installed on a computer, where the program is synced with at least one user's message receiving application; an avatar present when the program starts, where the avatar reads the messages available in the message receiving application; a voice selected for the avatar, where the voice is selected from a plurality of voices; and a voice recognition program, where the voice recognition program allows the user to voice command the avatar to operate the message receiving application. The message receiving application is an email mailbox or an instant message application. The use is able to customize the avatar by either uploading a photo, or selecting a plurality of facial features for the avatar's appearance.

### BACKGROUND OF THE INVENTION

1. Field of the Invention

The present invention relates to a computer system that allows a user to select an avatar on their computer to orally read their incoming messages while they are performing other tasks.

2. Description of Related Art

At work and at home, reading, deleting and sorting emails is a daily task that can be both fun and tedious for the average person. While receiving an email from a friend or family member is enjoyable when sending photos or catching up, repeatedly receiving promotional emails or scams is annoying. Many times the person would rather be doing other activities instead of sorting their emails, but it is a necessary task otherwise emails accumulate and important mail may be lost in the shuffle.

Because of the mass influx that many people receive, some people choose to check and sort emails while on the go and even driving. This is especially dangerous because the driver's attention is diverted from traffic as they view, read and even reply to the incoming messages. Many accidents and even fatalities have occurred on the roadways due to the driver being distracted by their smartphones.

Therefore it would be beneficial in the art to provide a way for a user to sort through their emails that is more entertaining than simply manually reading, reviewing and sorting their inbox. It would also be desirable in the art to provide a method for a user to safely review emails while driving.

### SUMMARY OF THE INVENTION

In view of the foregoing disadvantages inherent in the prior art, the general purpose of the present invention is to provide a system for an avatar to read an email, configured to include all of the advantages of the prior art, and to overcome the drawbacks inherent therein.

Accordingly, an object of the present invention is to provide a system to verbally read messages, where the system employs an avatar to animate and read the messages aloud.

Another object of the present invention is to provide a system with a voice recognition program that allows a user to voice command the avatar through the messaging operations.

To achieve the above objects, in an aspect of the present invention, a system for an avatar to read an email is described comprising a program installed on a computer, where the program is synced with at least one user's message receiving application; an avatar present when the program starts, where the avatar reads the messages available in the message receiving application; a voice selected for the avatar, where the voice is selected from a plurality of voices; and a voice recognition program, where the voice recognition program allows the user to voice command the avatar to operate the message receiving application. The message receiving application is an email mailbox or an instant message application. The use is able to customize the avatar by either uploading a photo, or selecting a plurality of facial features for the avatar's appearance.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 depicts a flowchart of a system for an avatar to read a message in accordance with an exemplary embodiment of the present invention; and

FIG. 2 depicts a flowchart of a system to select a plurality of features for an avatar in accordance with an exemplary embodiment of the present invention.

Like reference numerals refer to like parts throughout the description of several views of the drawings.

### DETAILED DESCRIPTION OF THE DRAWINGS

The present invention relates to a computer system that allows a user to select an avatar on their computer to orally read their incoming messages while they are performing other tasks. The present invention provides a system for an avatar to read a message thereby allowing the user to multitask at their computer. The system involves creating an avatar from either a variety of pre-programmed features or uploading a picture. The avatar is then able to read emails and instant messages received in the user's computer. The user may provide oral commands to the avatar instructing them how to proceed in reading the messages. With the system the user is able to listen to their messages while they multitask and perform other responsibilities in their home, office and/or vehicle.

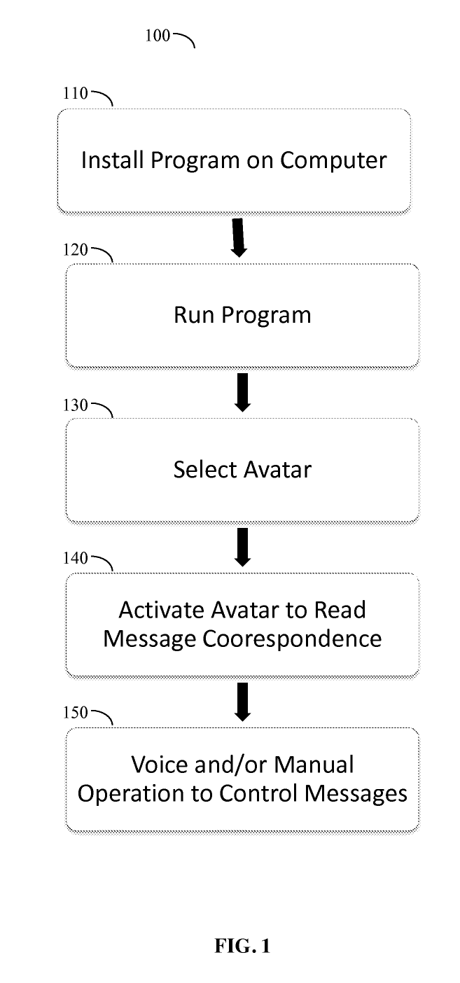

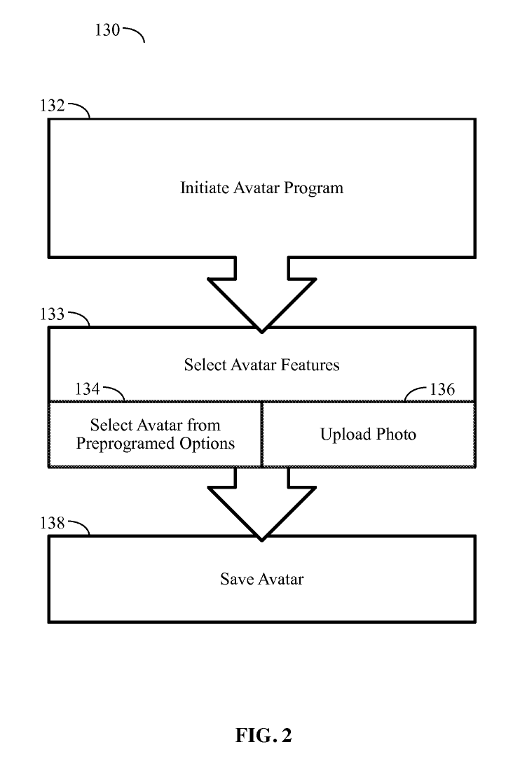

Turning now descriptively to the drawings, referring to FIG. 1, a flowchart of a system for an avatar to read a message 100 is shown in accordance with an exemplary embodiment of the present invention. The system 100 is initiated when a user installs a program to operate the system 100 on their computer 110. The program may either be downloaded from an online website or uploaded from a CD. The program may also be installed on a smartphone or tablet therefore allowing wider user portability. As such, the program may be converted into an app so that it is readily available for download on an online marketplace. Once the program is downloaded, the user runs the program 120 to initiate setup. During setup, the user's email mailbox and instant messaging applications are linked with the program thereby allowing access to the mailbox and instant messages by the program. The first selection is to create an avatar 130. Further detail in selecting the individual features of the avatar is explained below in reference to FIG. 2. The avatar is the animated computer character that voices all of the operations performed by the system 100. After the avatar is selected 130, the avatar is activated to read the user's messages and correspondence 140 from an email mailbox or instant messaging application. The avatar may read the message in its entirety as selected by the user.

The user is able to employ voice commands through a voice recognition program within the system 100 to operate how the avatar reads through the mailbox 150. Manual commands are also available to the user in case they choose not to verbally direct the avatar. The user is able to direct, either verbally or manually, the avatar to READ, STOP, SKIP, DELETE, MOVE, FORWARD, REPLY, COMPOSE and SEND messages. The voice recognition program allows the user to dictate a message which will be sent to the desired recipient. The voice commands may be specifically useful for users on the go who choose to sort their emails in their vehicle. While texting, emailing and all other computer operations are very dangerous in a vehicle, the system 100 allows the user to verbally command the avatar to sort their emails and text. The user then does not have to look away from traffic to listen to the messages, because the avatar is able to read them aloud.

Referring now to FIG. 2, a flowchart of how to create the avatar 130 is illustrated in accordance with an exemplary embodiment of the present invention. First the avatar's look and features are selected 133. The user may either select their avatar from a range of preprogrammed options 134 or the user may upload a photo to use as their avatar 136. After the avatar is selected 133 it is save 138 to use as the animated reading character for the system. The avatar may be altered as needed and desired by the user. Additionally the system is able to save multiple avatars thereby allowing more than one user to operate the system. For example, each member in a family may use the same computer and thus desire their own avatar to read for them from each of their mailboxes.

If the user chooses to create their avatar using the preprogrammed options 134, there are a variety of options available for their liking. A range to preprogrammed avatars may be available for selection each with preprogrammed features. Alternatively, the user may customize their avatar and create one from scratch. The user may choose whether their avatar is a male or female, or young or old. Other facial options are chosen like skin color, face shape, eye color, eye shape/expression, mouth shape, mouth expression, hair color, hair style, jewelry, tattoos, and the like. An optional feature is for the user to select the avatars voice and language. The voice may be especially important to some users since the avatar is reading aloud the emails thus a voice that sounds pleasant to the user is highly desirable. The voice may be selected from a variety of options including those with accents from different countries, male, female and/or regional dialects. For example, male or female American, Australian, British, Southern, New Yorker, Indian, Irish, Scottish and the like.

If the user uploads a photo for their avatar 136, they may select from the photos already available on their computer. Alternatively, the program may sync with other photo sharing websites to enable the user a wider range of photo selections. With the system for an avatar to read a message the user is afforded a unique operating tool that allows them to attend to other tasks while they have their messages read to them. The customized avatars make the experience fun and entertaining so that it's not simply a computer voice software, monotonously reading line after line.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A system for an avatar to read an message comprising;
a. a program installed on a computer, where the program is synced with at least one user's message receiving application;
b. an avatar present when the program starts, where the avatar reads the messages available in the message receiving application;
c. a voice selected for the avatar, where the voice is selected from a plurality of voices; and
d. a voice recognition program, where the voice recognition program allows the user to voice command the avatar to operate the message receiving application.

2. The system according to claim 1, where the message receiving application is an email mailbox.

3. The system according to claim 1, where the message receiving application is an instant message application.

4. The system according to claim 1, where the system is operational with more than one user, where each user operates at least one avatar per message receiving application.

5. The system according to claim 1, where the avatar is selected from a plurality of preprogrammed avatars.

6. The system according to claim 1, where the avatar is a photo uploaded to the system.

7. The system according to claim 6, where the photo is provided by a photo sharing website.

8. The system according to claim 1, where the avatar is customized by the user, where customization includes selecting one of at least male or female, young or old, skin color, face shape, eye color, eye shape, eye expression, mouth shape, mouth expression, hair color, hair style, jewelry, and tattoos.

9. The system according to claim 1, where the voice recognition program allows the user to verbally command the avatar to READ, STOP, SKIP, DELETE, FORWARD, MOVE and SEND messages.

10. The system according to claim 9, where the voice recognition program allows the user to dictate a correspondence, where dictation further allows the user to REPLY and COMPOSE messages.

11. The system according to claim 1, where the plurality of voices range from male, female, accents of different regional dialects, and accents of different countries.

12. The system according to claim 1, where the avatar is manually commanded by the user to operate the message receiving application.
